(19) United States
(12) Patent Application Publication
(10) Pub. No.: US 2016/0248762 A1
(43) Pub. Date: Aug. 25, 2016

(54) WIRELESS COMMUNICATION SYSTEM, AND ONE-TIME PASSWORD GENERATING AND AUTHENTICATING METHOD

(71) Applicant: Murata Manufacturing Co., Ltd., Nagaokakyo-shi (JP)

(72) Inventors: Kazuaki HIGASHIBATA, Nagaokakyo-shi (JP); Masato NOMURA, Nagaokakyo-shi (JP)

(21) Appl. No.: 15/144,909

(22) Filed: May 3, 2016

Related U.S. Application Data
(63) Continuation of application No. PCT/JP2014/073214, filed on Sep. 3, 2014.

(30) Foreign Application Priority Data
Nov. 6, 2013 (JP) 2013-229878

(51) Int. Cl. H04L 29/06; G06K 19/07; H04W 4/00; H04W 12/06

(52) U.S. Cl. CPC H04L 63/0838; H04W 12/06; G06K 19/0727; H04W 4/008

(57) ABSTRACT

A wireless communication system includes a mobile terminal that performs a one-time password generating function, a fixed terminal capable of activating a necessary operation in response to authentication of an entered one-time password, and a server connected to the fixed terminal. The fixed terminal includes an RFID tag. The mobile terminal includes an RFID reader/writer capable of performing RFID communication with the tag, and a first generator that is connected to the reader/writer and that generates a first one-time password based on ID information of the tag. The server includes a second generator that generates a second one-time password based on the ID information of the tag, and an authenticator that checks and authenticates the first one-time password and the second one-time password. The first and second generators generate the first and second one-time passwords, respectively, from the ID information of the tag based on a rule common to both generators.

### BACKGROUND OF THE INVENTION

1. Field of the Invention

The present invention relates to a wireless communication system, and more particularly to a wireless communication system that generates and authenticates a one-time password by communicating with a fixed terminal such as a mobile terminal or a personal computer by using an RFID (Radio Frequency Identification) system, and also relates to a one-time password generating and authenticating method executed using this system.

2. Description of the Related Art

An RFID system has been put to practical use in recent years as a system for managing information on articles. In this system, a reader/writer that generates an inductive magnetic field communicates with and conveys certain information to an RFID tag attached to each article by using a contactless method utilizing a magnetic field or electromagnetic field.

Meanwhile, an authentication system for allowing communication between a particular communication terminal and a server has been developed. However, in a general authentication method of transmitting a password associated with a user name, the password may be “overheard” or intercepted on a communication path from the terminal to the server.

To this end, one-time passwords (also referred to as disposable passwords) are beginning to spread. Japanese Unexamined Patent Application Publication No. 2002-007355 describes an authentication technique of verifying whether a person who is trying to gain remote access to a server from a terminal located at a remote place is a legitimate user.

Generally, in a first authentication method using a one-time password, the server first transmits to the terminal a random character string (called a “challenge”) which serves as the “seed” of an authentication character string. The user enters a secret password that the user only knows on his/her terminal. Software on the terminal performs an arithmetic operation on the challenge character string, transmitted from the server, and the password, entered by the user, in accordance with a certain procedure, and transmits the generated result (a character string called a “response”) to the server. The server verifies the received character string and checks whether the user is a legitimate user. A challenge is set to be a different character string every time, and the password entered by the user is transmitted every time as a different character string to the server.

The following method is known as a second authentication method. In this method, a one-time password is generated by a “security token” in the form of a keychain, or by a “software token” which is an application for smartphones, and then that password is entered by the user with his/her own hands.

Using a one-time password prevents an unauthorized use of the server even if information transmitted and received on a communication path between the server and the terminal is overheard, because the same password cannot be used twice. Meanwhile, the user needs to “generate a password” and to “input that password”, which is bothersome for the user.

### SUMMARY OF THE INVENTION

Preferred embodiments of the present invention provide a wireless communication system and a one-time password generating and authenticating method that generate and authenticate a one-time password with a simple method.

A wireless communication system according to a first preferred embodiment of the present invention includes a mobile terminal that performs a one-time password generating function; a fixed terminal capable of activating a necessary operation in response to authentication of an entered one-time password; and a server connected to the fixed terminal, wherein the fixed terminal includes an RFID tag, the mobile terminal includes an RFID reader/writer capable of performing RFID communication with the RFID tag, and a first one-time password generator that is connected to the RFID reader/writer and that generates a first one-time password based on ID information of the RFID tag, the server includes a second one-time password generator that generates a second one-time password based on the ID information of the RFID tag, and an authenticator that checks and authenticates the first one-time password and the second one-time password, and the first one-time password generator and the second one-time password generator generate the first one-time password and the second one-time password, respectively, from the ID information of the RFID tag based on a rule common to both generators.

A wireless communication system according to a second preferred embodiment of the present invention includes a server; a mobile terminal including a wireless communication system capable of communicating with the server; and a fixed terminal connected to the server and capable of activating a necessary operation in response to authentication of an entered one-time password, wherein the fixed terminal includes an RFID tag, the mobile terminal includes an RFID reader/writer capable of performing RFID communication with the RFID tag, and a one-time password generator that is connected to the RFID reader/writer and that generates a one-time password based on ID information of the RFID tag, and the server includes an authenticator that checks and authenticates a one-time password directly transmitted from the mobile terminal through the wireless communication system, and a one-time password indirectly transmitted from the mobile terminal via the RFID communication and the fixed terminal.

A wireless communication system according to a third preferred embodiment includes a server that performs a one-time password generating function; a mobile terminal including a wireless communication system capable of communicating with the server; and a fixed terminal connected to the server and capable of activating a necessary operation in response to authentication of an entered one-time password, wherein the fixed terminal includes an RFID tag, the mobile terminal includes an RFID reader/writer capable of performing RFID communication with the RFID tag, and the server includes a one-time password generator that generates a one-time password based on ID information of the RFID tag directly transmitted from the mobile terminal through the wireless communication system, and an authenticator that checks and authenticates a one-time password indirectly transmitted from the mobile terminal via the fixed terminal.

A one-time password generating and authenticating method according to a fourth preferred embodiment of the present invention includes a step of reading, by an RFID reader/writer included in a mobile terminal, an RFID tag included in a fixed terminal by using an RFID communication system; a step of generating, by the mobile terminal, a one-time password based on a predetermined rule by using information of the read RFID tag; a step of transferring the generated one-time password from the RFID reader/writer to the RFID tag by using the RFID communication system; a step of transferring the one-time password and the information of the RFID tag from the fixed terminal to a server; and a step of generating, by the server, a one-time password based on the predetermined rule by using the information of the RFID tag, and checking and authenticating, by the server, the one-time password generated here and the one-time password transferred from the fixed terminal.

A one-time password generating and authenticating method according to a fifth preferred embodiment of the present invention includes a step of reading, by an RFID reader/writer included in a mobile terminal, an RFID tag included in a fixed terminal by using an RFID communication system; a step of generating, by the mobile terminal, a one-time password based on information of the read RFID tag; a step of transferring the generated one-time password from the RFID reader/writer to the RFID tag by using the RFID communication system, and further to a server; a step of transferring the one-time password from the mobile terminal to the server by using a wireless communication system different from the RFID communication system; and a step of checking and authenticating, by the server, the one-time password transferred from the fixed terminal and the one-time password transferred from the mobile terminal.

A one-time password generating and authenticating method according to a sixth preferred embodiment of the present invention includes a step of reading, by an RFID reader/writer included in a mobile terminal, an RFID tag included in a fixed terminal by using an RFID communication system; a step of transferring information of the read RFID tag from the mobile terminal to a server by using a wireless communication system different from the RFID communication system; generating, by the server, a one-time password based on the information of the RFID tag; and downloading the one-time password to the mobile terminal; a step of transferring the downloaded one-time password from the RFID reader/writer to the RFID tag by using the RFID communication system; a step of transferring the one-time password from the fixed terminal to the server; and a step of checking and authenticating, by the server, the one-time password generated by the server and the one-time password transferred from the fixed terminal.

In the wireless communication systems and the one-time password generating and authenticating methods, by holding the mobile terminal close to the fixed terminal, the reader/writer included in the mobile terminal reads information of the RFID device (RFID tag) included in the fixed terminal, the mobile terminal or the server generates a one-time password, and the server automatically authenticates the one-time password.

According to various preferred embodiments of the present invention, a one-time password is able to be generated and authenticated with a simple method, and accordingly user authentication is able to be simply and quickly performed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A and 1B are both block diagrams illustrating a schematic configuration of a wireless communication system according to a first preferred embodiment of the present invention.

FIG. 2 is a flowchart illustrating a first method of generating and authenticating a one-time password.

FIGS. 3A and 3B are both block diagrams illustrating a schematic configuration of a wireless communication system according to a second preferred embodiment of the present invention.

FIG. 4 is a flowchart illustrating a second method of generating and authenticating a one-time password.

FIGS. 5A and 5B are both block diagrams illustrating a schematic configuration of a wireless communication system according to a third preferred embodiment of the present invention.

FIG. 6 is a flowchart illustrating a third method of generating and authenticating a one-time password.

### DETAILED DESCRIPTION OF THE PREFERRED EMBODIMENTS

Hereinafter, preferred embodiments of wireless communication systems and one-time password generating and authenticating methods according to the present invention will be described with reference to the accompanying drawings.

### First Preferred Embodiment

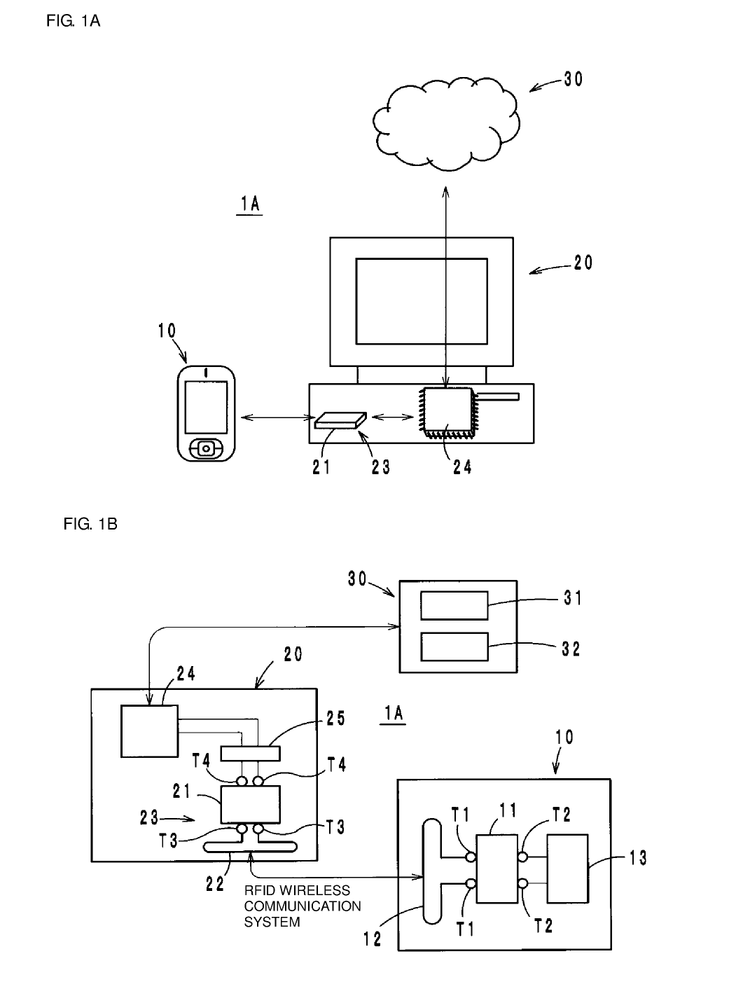

FIGS. 1A and 1B illustrate a wireless communication system 1A according to a first preferred embodiment of the present invention. The wireless communication system 1A includes a mobile terminal 10 (such as a smartphone) that performs a one-time password generating function, and a fixed terminal 20 (such as a desktop personal computer) capable of activating a necessary operation in response to authentication of an entered one-time password. There is further provided a server 30. The server 30 stores various types of information accessible to the fixed terminal 20. The server 30 also generates and authenticates a one-time password.

The mobile terminal 10 includes a reader/writer device with antenna connection terminals T1 and CPU connection terminals T2, a reader/writer antenna 12 connected to the antenna connection terminals T1, and a first CPU 13 connected to the CPU connection terminals T2. The reader/writer device 11 includes a reader/writer IC. The reader/writer device 11 and the reader/writer antenna 12 define an RFID reader/writer. The first CPU 13 includes a first one-time password generating circuit that generates a first one-time password based on a predetermined rule (regularity) by using ID information of an RFID tag 23 described hereinafter.

The fixed terminal 20 includes a tag device 21 including antenna connection terminals T3 and CPU connection terminals T4, a tag antenna 22 connected to the antenna connection terminals T3, and a second CPU 24 connected to the CPU connection terminals T4 with an interface 25 provided therebetween. The tag device 21 includes a tag IC device. The second CPU 24 is connected to the server 30 via wire or wirelessly. Note that the tag device 21 and the antenna 22 are collectively referred to as the RFID tag 23. A device manufactured in accordance with various standards, such as I²C, UART, and SPI, can be used as the interface 25.

The server 30 is configured or programmed to include a second one-time password generator 31 that generates a second one-time password based on the ID information of the RFID tag 23. The server 30 also is configured or programmed to include an authenticator in the form of a checking/authenticating circuit 32 that checks and authenticates the first one-time password and the second one-time password.

The first one-time password generator (CPU 13) in the mobile terminal 10 and the second one-time password generator 31 in the server 30 generate the first one-time password and the second one-time password, respectively, from the ID information of the RFID tag 23 based on a rule common to both generators.

The RFID communication between the mobile terminal 10 and the fixed terminal 20 (more specifically, communication between the RFID reader/writer and the RFID tag 23) may use the RFID communication system using the HF band or the RFID communication system using the UHF band.

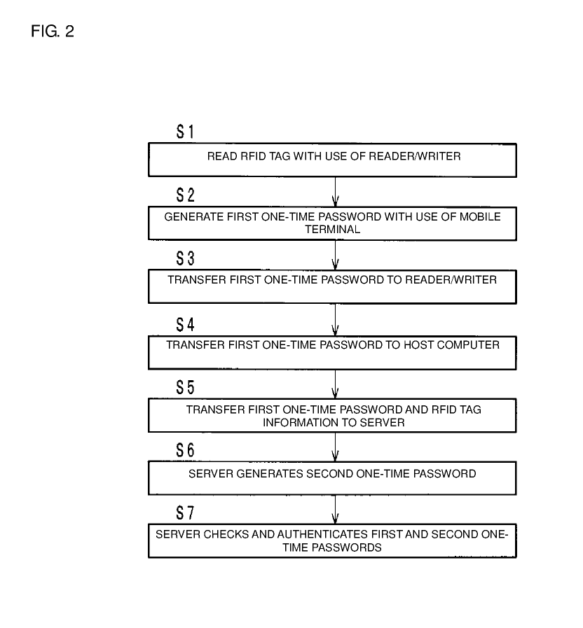

Now, a first method regarding generation and authentication of a one-time password using the wireless communication system 1A will be described based on FIG. 2.

At first, the RFID tag 23 included in the fixed terminal 20 is read by the RFID reader/writer included in the mobile terminal 10 (step S1). More specifically, the tag device 21 in the RFID tag 23 stores unique ID information, and this ID information is read by the RFID reader/writer. Next, the mobile terminal 10 (CPU 13) generates the first one-time password based on the read RFID tag information (step S2). In other words, the mobile terminal 10 generates the first one-time password by using the ID information of the RFID tag 23 based on a predetermined rule (regularity). A process of generating a one-time password with regard to the user, namely, the ID information of the tag 23, can use a known method.

Next, the first one-time password generated by the one-time password generator of the CPU 13 is transferred to the RFID reader/writer (step S3). Next, the first one-time password from the RFID reader/writer is transferred to a host computer (CPU 24) of the fixed terminal 20 via the RFID tag 23 and the interface 25 (step S4). The first one-time password transferred to the host computer (CPU 24) and the RFID tag information are transferred to the server 30 (step S5). The checking/authenticating circuit 32 in the server 30 authenticates the first one-time password (step S7). Like the above-described case, the server 30 includes the generator 32 which generates the second one-time password by using the ID information of the RFID tag 23 based on the predetermined rule. Whether the second one-time password generated in step S6 matches the first one-time password, that is, whether the first one-time password generated by the mobile terminal 10 is the true password, is checked.

Through the above steps, the server 30 checks and authenticates the one-time password. After that, the fixed terminal 20 is able to start accessing the server 30 for the first time. Since the one-time password is a single-use and disposable password, an unauthorized use of the server 30 is less likely to happen. By holding the reader/writer antenna 12 of the mobile terminal 10 near the fixed terminal 20, the reader/writer included in the mobile terminal 10 reads information of the RFID tag 23 included in the fixed terminal 20, the mobile terminal 10 generates a one-time password, and the server 30 automatically authenticates the one-time password. Therefore, the user need not perform a special operation, and a one-time password is able to be generated and authenticated with a simple method. In other words, since the above-described steps require no operations, such as entering of a password by the user, security is further enhanced by periodically executing these steps. The mobile terminal 10 according to the first preferred embodiment need not be a phone terminal with a cellular function, such as a smartphone. The mobile terminal 10 may alternatively be a terminal such as an electronic key.

### Second Preferred Embodiment

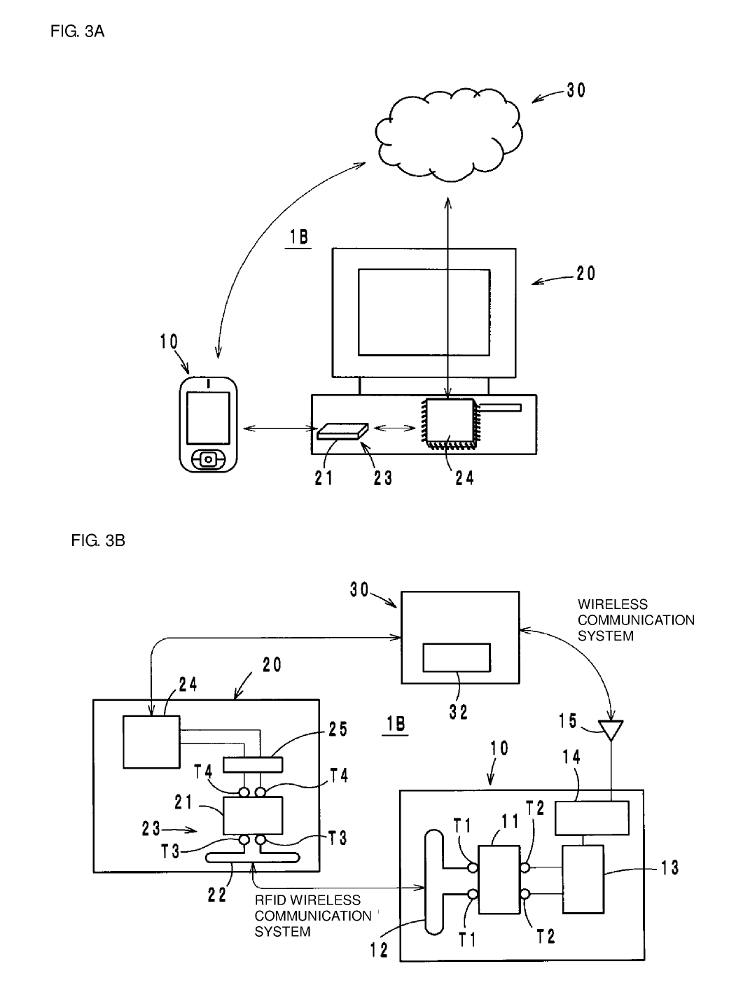

FIGS. 3A and 3B illustrate a wireless communication system 1B according to a second preferred embodiment of the present invention. The wireless communication system 1B includes a mobile terminal 10 (such as a smartphone) with a one-time password generating function, and a fixed terminal 20 (such as a desktop personal computer) capable of activating a necessary operation in response to authentication of an entered one-time password. There is further provided a server 30. The server 30 stores various types of information accessible to the fixed terminal 20. The server 30 also checks and authenticates a one-time password.

The mobile terminal 10 includes a reader/writer device with antenna connection terminals T1 and CPU connection terminals T2, a reader/writer antenna 12 connected to the antenna connection terminals T1, a first CPU 13 connected to the CPU connection terminals T2, a wireless communication circuit 14 connected to the first CPU 13, and a wireless communication antenna 15 connected to the wireless communication circuit 14. The reader/writer device 11 includes a reader/writer IC. The reader/writer device 11 and the reader/writer antenna 12 define an RFID reader/writer. The first CPU 13 includes a one-time password generating circuit that generates a first one-time password by using ID information of an RFID tag 23 described hereinafter. The wireless communication circuit 14 is a communication circuit that performs cellular communication, WiFi communication, Bluetooth (registered trademark) communication, or the like. The antenna 15 is an antenna device that performs cellular communication, WiFi communication, Bluetooth communication, or the like.

The fixed terminal 20 includes a tag device 21 including antenna connection terminals T3 and CPU connection terminals T4, a tag antenna 22 connected to the antenna connection terminals T3, and a second CPU 24 connected to the CPU connection terminals T4 with an interface 25 provided therebetween. The tag device 21 includes a tag IC device. The second CPU 24 is connected to the server 30 via wire or wirelessly. In other words, the fixed terminal 20 and the server 30 are connected by a communication system other than the RFID communication system. Note that the tag device 21 and the antenna 22 are collectively referred to as the RFID tag 23. A device manufactured in accordance with various standards, such as I²C, UART, and SPI, can be used as the interface 25.

The RFID communication between the mobile terminal 10 and the fixed terminal 20 may use the RFID communication system using the HF band or the RFID communication system using the UHF band. Communication between the mobile terminal 10 and the server 30 can use cellular communication, WiFi communication, Bluetooth communication, or the like.

The server 30 is configured or programmed to include an authenticator in the form of a checking/authenticating circuit 32 that checks and authenticates a one-time password directly transmitted from the mobile terminal 10 through the wireless communication system, and a one-time password indirectly transmitted from the mobile terminal 10 via the RFID communication and the fixed terminal 20.

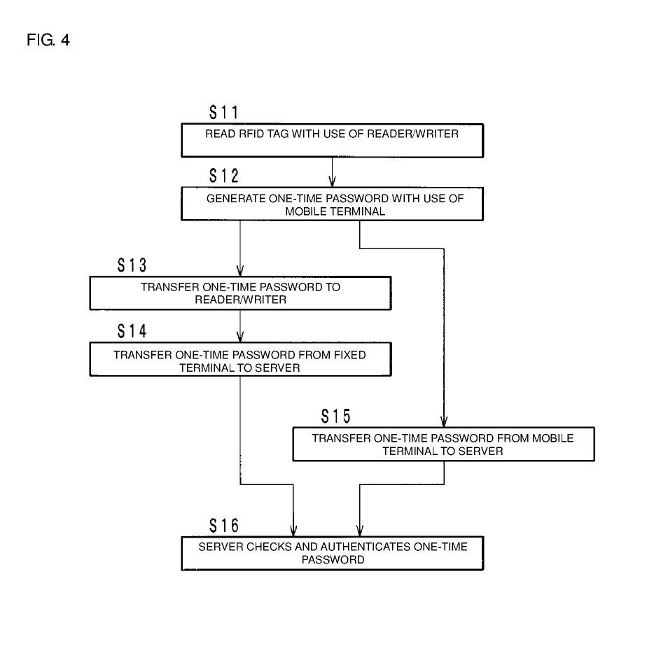

Now, a second method regarding generation and authentication of a one-time password using the wireless communication system 1B will be described based on FIG. 4.

At first, the RFID tag 23 included in the fixed terminal 20 is read by the RFID reader/writer included in the mobile terminal 10 (step S11). More specifically, the tag device 21 in the RFID tag 23 stores unique ID information, and this ID information is read by the RFID reader/writer. Next, the mobile terminal 10 (CPU 13) generates a one-time password based on the read RFID tag information (step S12). The one-time password may be generated based on a predetermined rule (regularity) or may be generated at random. However, it is preferable that the one-time password be generated at random. In other words, it is preferable that the one-time password be a password unknown to the server 30.

Next, the one-time password generated by the one-time password generator of the CPU 13 is transferred to the RFID reader/writer (step S13). In other words, the one-time password is transferred from the mobile terminal 10 to the fixed terminal 20. Next, the one-time password is transferred from the fixed terminal 20 to the server 30 (step S14). At the same time, the one-time password is transferred to the server 30 via the wireless communication system (e g., a wireless phone line such as a cellular line, WiFi, or Bluetooth) of the mobile terminal (step S15). In other words, the one-time password generated by the CPU 13 is transmitted to the server 30 using the wireless communication circuit 14 and the antenna 15. The checking/authenticating circuit 32 in the server 30 checks the one-time password directly transmitted from the mobile terminal 10 against the one-time password indirectly transmitted via the fixed terminal 20, and performs an authentication job (step S16).

Through the above steps, the server 30 checks and authenticates the one-time password. After that, the fixed terminal 20 is able to start accessing the server 30 for the first time. Since the one-time password is a single-use and disposable password, an unauthorized use of the server 30 is less likely to happen. Since it is not necessary for the mobile terminal 10 and the server 30 to share a predetermined password generating rule, security is able to be further enhanced. By holding the reader/writer antenna 12 of the mobile terminal 10 close to the fixed terminal 20, the server 30 automatically checks and authenticates the one-time password. The user need not perform a complicated operation. Security is further enhanced by periodically executing the foregoing steps. In other words, when the fixed terminal 20 is used while the mobile terminal 10 is held close to the fixed terminal 20, a one-time password is able to be periodically issued and authenticated while the terminals 10 an 20 are held close to each other, thus further enhancing security.

### Third Preferred Embodiment

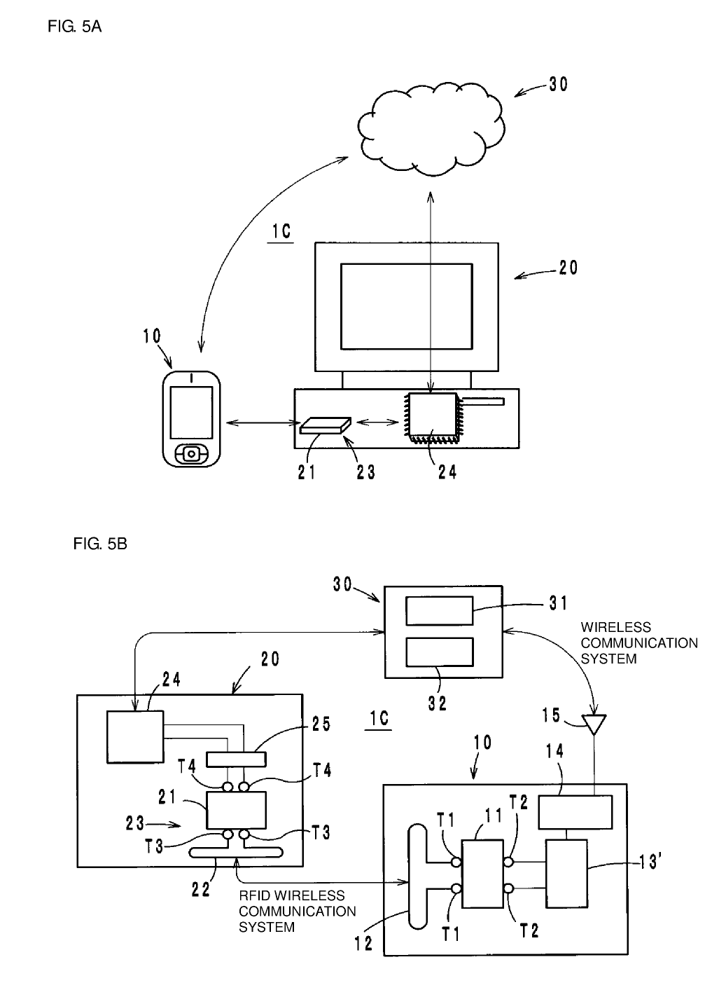

In the wireless communication system 1A illustrated in FIG. 1, the mobile terminal 10 may not perform a one-time password generating function, and only the server 30 may perform a one-time password generating function, for example. Such a wireless communication system 1C is described as a third preferred embodiment of the present invention with reference to FIGS. 5A and 5B. The wireless communication system 1C includes a mobile terminal 10 (such as a smartphone), and a fixed terminal (such as a desktop personal computer) capable of activating a necessary operation in response to authentication of an entered one-time password. There is further provided a server 30. The server 30 stores various types of information accessible to the fixed terminal 20. The server 30 also generates and authenticates a one-time password.

The mobile terminal 10 includes a reader/writer device with antenna connection terminals T1 and CPU connection terminals T2, a reader/writer antenna 12 connected to the antenna connection terminals T1, a first CPU 13′ connected to the CPU connection terminals T2, a wireless communication circuit 14 connected to the first CPU 13′, and a wireless communication antenna 15 connected to the wireless communication circuit 14. The reader/writer device 11 includes a reader/writer IC. The reader/writer device 11 and the reader/writer antenna 12 define an RFID reader/writer. The first CPU 13′ does not have a one-time password generating circuit, unlike the first preferred embodiment and the second preferred embodiment. The wireless communication circuit 14 is a communication circuit that performs cellular communication, WiFi communication, Bluetooth communication, or the like. The antenna 15 is an antenna device that performs cellular communication, WiFi communication, Bluetooth communication, or the like.

The fixed terminal 20 includes a tag device 21 including antenna connection terminals T3 and CPU connection terminals T4, a tag antenna 22 connected to the antenna connection terminals T3, and a second CPU 24 connected to the CPU connection terminals T4 with an interface 25 provided therebetween. The tag device 21 includes a tag IC device. The second CPU 24 is connected to the server 30 via wire or wirelessly. In other words, the fixed terminal 20 and the server 30 are connected by a communication system other than the RFID communication system. Note that the tag device 21 and the antenna 22 are collectively referred to as the RFID tag 23. A device manufactured in accordance with various standards, such as I²C, UART, and SPI, can be used as the interface 25.

The RFID communication between the mobile terminal 10 and the fixed terminal 20 may use the RFID communication system using the HF band or the RFID communication system using the UHF band. Communication between the mobile terminal 10 and the server 30 can use cellular communication, WiFi communication, Bluetooth communication, or the like.

The server 30 is configured or programmed to include a one-time password generator 31 that generates a one-time password based on the ID information of the RFID tag 23. The server 30 is also configured or programmed to include an authenticator in the form of a checking/authenticating circuit 32 that checks and authenticates a one-time password generated by the generator 31 and downloaded by the mobile terminal 10 and a second one-time password.

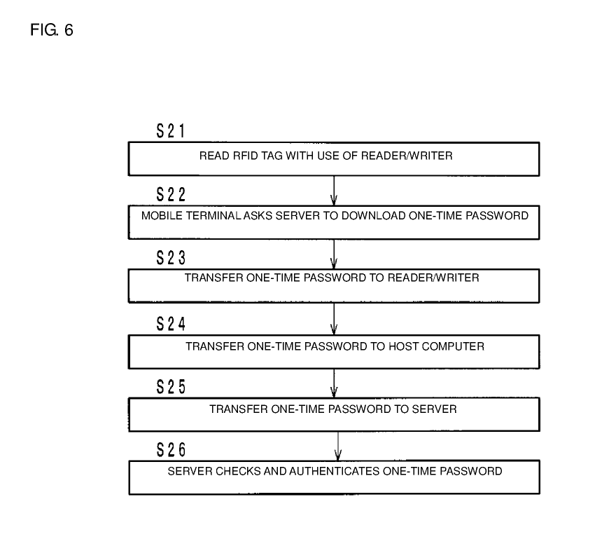

Now, a third method regarding generation and authentication of a one-time password using the wireless communication system 1C will be described based on FIG. 6.

At first, the RFID tag 23 included in the fixed terminal 20 is read by the RFID reader/writer included in the mobile terminal 10 (step S21). More specifically, the tag device 21 in the RFID tag 23 stores unique ID information, and this ID information is read by the RFID reader/writer. Next, the mobile terminal 10 asks the server 30 based on the read RFID tag information, and downloads a one-time password from the server (step S22). That is, the mobile terminal 10 transmits the ID information of the RFID tag 23 to the server 30, and requests the server 30 to generate a one-time password based on the ID information (a password associated with the ID information). In response to this in the server 30, the one-time password generator 31 generates a one-time password based on the RFID information.

Next, the one-time password downloaded from the server is transferred to the RFID reader/writer (step S23). Next, the one-time password is transferred from the RFID reader/writer to a host computer (CPU 24) of the fixed terminal 20 (step S24). Next, the fixed terminal 20 transfers the one-time password, transferred to the host computer (CPU 24), to the server 30 (step S25). The checking/authenticating circuit 32 in the server checks and authenticates the one-time password transmitted from the fixed terminal 20 against the one-time password generated by the generator 31, and performs an authentication job (step S26).

Through the above steps, the server 30 checks and authenticates the one-time password. After that, the fixed terminal 20 is able to start accessing the server 30 for the first time. The third method is different from the second method in the point that the server 30 generates a one-time password. However, the third method has basically the same operation and effects as those of the first and second methods. In other words, since the one-time password is a single-use and disposable password, an unauthorized use of the server 30 is less likely to happen. In particular, since the mobile terminal 10 has no one-time password generating circuit, the mobile terminal 10 is able to be made more compact, and security is further enhanced. By holding the reader/writer antenna 12 of the mobile terminal 10 close to the fixed terminal 20, the server 30 automatically checks and authenticates the one-time password. The user need not perform a complicated operation. Security is further enhanced by periodically executing the foregoing steps. In other words, when the fixed terminal 20 is used while the mobile terminal 10 is held close to the fixed terminal 20, a one-time password is able to be periodically issued and authenticated while the terminals 10 and 20 are held close to each other, thus further enhancing security.

Although the wireless communication systems and the one-time password generating and checking methods have been described so far based on the specific preferred embodiments, the wireless communication systems and the one-time password generating and authenticating methods according to the present invention are not limited to the foregoing preferred embodiments, and various changes can be made within the scope of the gist of the present invention.

In particular, the configuration of the reader/writer, RFID tag, or antenna is arbitrary. It is only necessary for the RFID tag to be an element that at least performs a tag function. The RFID tag may perform both a reader/writer function and a tag function.

As has been described above, preferred embodiments of the present invention are useful in a wireless communication system and a one-time password generating and authenticating method, and preferred embodiments of the present invention are particularly advantageous in the point that a one-time password can be generated and authenticated with a simple method.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A wireless communication system comprising:
a mobile terminal that performs a one-time password generating function;
a server; and
a fixed terminal connected to the server and capable of starting accessing the server in response to authentication of an entered one-time password; wherein
the fixed terminal includes an RFID tag;
the mobile terminal includes an RFID reader/writer capable of performing RFID communication with the RFID tag, and a first one-time password generator that is connected to the RFID reader/writer and that generates a first one-time password based on ID information of the RFID tag;
the server includes a second one-time password generator that generates a second one-time password based on the ID information of the RFID tag, and an authenticator that checks and authenticates the first one-time password and the second one-time password; and
the first one-time password generator and the second one-time password generator generate the first one-time password and the second one-time password, respectively, from the ID information of the RFID tag based on a rule common to both generators.

2. The wireless communication system according to claim 1, wherein the mobile terminal is a smartphone.

3. The wireless communication system according to claim 1, wherein the fixed terminal is a computer.

4. The wireless communication system according to claim 1, wherein the RFID communication between the mobile terminal and the RFID tag uses an RFID communication system using the HF band or an RFID communication system using the UHF band.

5. The wireless communication system according to claim 1, wherein the RFID tag includes an antenna that when positioned near the fixed terminal to enable the mobile terminal to read the ID information of the RFID tag.

6. A wireless communication system comprising:
a server;
a mobile terminal including a wireless communication system capable of communicating with the server; and
a fixed terminal connected to the server and capable of starting accessing the server in response to authentication of an entered one-time password; wherein
the fixed terminal includes an RFID tag;
the mobile terminal includes an RFID reader/writer capable of performing RFID communication with the RFID tag, and a one-time password generator that is connected to the RFID reader/writer and that generates a one-time password based on ID information of the RFID tag; and
the server includes an authenticator that checks and authenticates a one-time password directly transmitted from the mobile terminal through the wireless communication system, and a one-time password indirectly transmitted from the mobile terminal via the RFID communication and the fixed terminal.

7. A wireless communication system comprising:
a server that performs a one-time password generating function;
a mobile terminal including a wireless communication system capable of communicating with the server; and
a fixed terminal connected to the server and capable of starting accessing the server in response to authentication of an entered one-time password; wherein
the fixed terminal includes an RFID tag;
the mobile terminal includes an RFID reader/writer capable of performing RFID communication with the RFID tag;
the server includes a one-time password generator that generates a one-time password based on ID information of the RFID tag directly transmitted from the mobile terminal through the wireless communication system, and an authenticator;
the mobile terminal transfers, after the one-time password generated by the one-time password generator is downloaded to the mobile terminal, the one-time password from the RFID reader/writer to the RFID tag by using the RFID communication system;
the fixed terminal transfers the one-time password to the server; and
the authenticator checks and authenticates the one-time password indirectly transmitted from the mobile terminal via the fixed terminal.

8. The wireless communication system according to claim 7, wherein the mobile terminal is a smartphone.

9. The wireless communication system according to claim 7, wherein the fixed terminal is a computer.

10. The wireless communication system according to claim 7, wherein the RFID communication between the mobile terminal and the RFID tag uses an RFID communication system using the HF band or an RFID communication system using the UHF band.

11. The wireless communication system according to claim 7, wherein the RFID tag includes an antenna that when positioned near the fixed terminal to enable the mobile terminal to read the ID information of the RFID tag.

12. The wireless communication system according to claim 7, wherein the mobile terminal includes a wireless communication circuit and a wireless communication antenna that perform wireless communication.

13. The wireless communication system according to claim 7, wherein the fixed terminal and the server are connected by a communication system other than an RFID communication system.

14. A one-time password generating and authenticating method comprising:
a step of reading, by an RFID reader/writer included in a mobile terminal, an RFID tag included in a fixed terminal by using an RFID communication system;
a step of generating, by the mobile terminal, a one-time password based on a predetermined rule by using information of the read RFID tag;
a step of transferring the generated one-time password from the RFID reader/writer to the RFID tag by using the RFID communication system;
a step of transferring the one-time password and the information of the RFID tag from the fixed terminal to a server; and
a step of generating, by the server, a one-time password based on the predetermined rule by using the information of the RFID tag, and, in order for the fixed terminal to start accessing the server, checking and authenticating, by the server, the one-time password generated here and the one-time password transferred from the fixed terminal.

15. A one-time password generating and authenticating method comprising:
a step of reading, by an RFID reader/writer included in a mobile terminal, an RFID tag included in a fixed terminal by using an RFID communication system;
a step of generating, by the mobile terminal, a one-time password based on information of the read RFID tag;
a step of transferring the generated one-time password from the RFID reader/writer to the RFID tag by using the RFID communication system, and further to a server;
a step of transferring the one-time password from the mobile terminal to the server by using a wireless communication system different from the RFID communication system; and
a step of checking and authenticating, by the server, the one-time password transferred from the fixed terminal and the one-time password transferred from the mobile terminal, in order for the fixed terminal to start accessing the server.

16. The wireless communication system according to claim 15, wherein the mobile terminal is a smartphone.

17. The wireless communication system according to claim 15, wherein the fixed terminal is a computer.

18. The wireless communication system according to claim 15, wherein the RFID communication between the mobile terminal and the RFID tag uses an RFID communication system using the HF band or an RFID communication system using the UHF band.

19. The wireless communication system according to claim 15, wherein the RFID tag includes an antenna that when positioned near the fixed terminal to enable the mobile terminal to read the ID information of the RFID tag.

20. A one-time password generating and authenticating method comprising:
a step of reading, by an RFID reader/writer included in a mobile terminal, an RFID tag included in a fixed terminal by using an RFID communication system;
a step of transferring information of the read RFID tag from the mobile terminal to a server by using a wireless communication system different from the RFID communication system; generating, by the server, a one-time password based on the information of the RFID tag; and downloading the one-time password to the mobile terminal;
a step of transferring the downloaded one-time password from the RFID reader/writer to the RFID tag by using the RFID communication system;
a step of transferring the one-time password from the fixed terminal to the server; and
a step of checking and authenticating, by the server, the one-time password generated by the server and the one-time password transferred from the fixed terminal, in order for the fixed terminal to start accessing the server.
